(19) United States
(12) Patent Application Publication
(10) Pub. No.: US 2026/0254902 A1
(43) Pub. Date: Aug. 27, 2026

(54) DETACHABLE SCANNING DEVICE

(71) Applicant: KINPO ELECTRONICS, INC., NEW TAIPEI CITY (TW)

(72) Inventors: Po-Chih CHANG, NEW TAIPEI CITY (TW); Yu-Ying YU, NEW TAIPEI CITY (TW)

(21) Appl. No.: 19/063,588

(22) Filed: Feb. 26, 2025

(30) Foreign Application Priority Data
Dec. 20, 2024 (CN) 202411888651.9

(51) Int. Cl. H04N 1/00

(52) U.S. Cl. CPC H04N 1/00541; H04N 1/00557; H04N 1/00588; H04N 1/00602

(57) ABSTRACT

This disclosure is directed to a detachable scanning device for scanning a document, the detachable scanning device has a power transmission module and a scanning module, the power transmission module has at least one of an automatic sheet feeding mechanism and a flat drag mechanism, the automatic sheet feeding mechanism has a channel roller group, the flat drag mechanism has a transferring part, the scanning module is detachably connected to the power transmission module and provided with an image sensor. When the scanning module is connected to the automatic sheet feeding mechanism, the channel roller group may transfer the document to be scanned by an image sensor. When the scanning module is connected to a flat drag mechanism, the transferring part may move the image sensor for scanning the document. Therefore, a user may select the power transmission module which may be quickly assembled or detached according to various requirements.

### BACKGROUND OF THE INVENTION

### Technical Field

This disclosure is directed to a scanning device, in particular to a detachable scanning device.

### Description of Related Art

Copying, scanning and printing are common requirements in daily life, and may be required in homes, shops, schools, offices, government agencies or companies. For a consumer, various types of copy machines such as printers, scanners and multi-function printers are available in the market. However, most of the devices mentioned above have only single function, they should be purchased respectively according to various required functions. Accordingly, multiple devices occupy spaces, and the devices should be respectively set up and connected in advance for operations. This is inconvenient to the user. Although a multi-function printer has multiple functions, it is expensive and large, and it would not be chosen by a user without requirements of all of the functions. Therefore, it is an urgent need to develop a scanning device with functions of a combination of selectable modules according to various operation requirements.

In views of this, in order to solve the above disadvantage, the inventor studied related technology and provided a reasonable and effective solution in this disclosure.

### SUMMARY OF THE INVENTION

This disclosure has a main purpose for allowing a user to select the power transmission module which may be quickly assembled or detached according to various requirements.

In order to achieve the above-mentioned purpose, this disclosure is directed to a detachable scanning device for scanning a document to be scanned. The detachable scanning device has at least one of a power transmission module and a scanning module. The power transmission module has at least one of an automatic sheet feeding mechanism and a flat drag mechanism. The automatic sheet feeding mechanism has a channel roller group. The flat drag mechanism has a casing and a transferring part. The transferring part is arranged in the casing to perform a reciprocating motion along a lateral direction. The scanning module is detachably connected to the power transmission module and provided with a housing and an image sensor. The image sensor is movably disposed in the housing. When the scanning module is connected to the automatic sheet feeding mechanism, the channel roller group may transfer the document to be scanned along a scanning path to be scanned by an image sensor. When the scanning module is connected to a flat drag mechanism, the transferring part may move the image sensor into the casing from the housing for scanning the document to be scanned.

In one embodiment of this disclosure, the flat drag mechanism further has a driver, the scanning module further has a connecting piece, the connecting piece is arranged on the image sensor, the connecting piece is connected to the transferring part when the scanning module is connected to the flat drag mechanism, so that the driver can drive the transferring part to move the image sensor along the lateral direction.

In one embodiment of this disclosure, the flat drag mechanism further has a slide rod, the slide rod is fixed in the casing and extended along the lateral direction, the transferring part sleeves the slide rod and disposed on the slide rod to be slidable along the lateral direction.

In one embodiment of this disclosure, the scanning module further has a connecting rod, the connecting rod is arranged in the housing, and the connecting rod is assembled with the slide rod.

In one embodiment of this disclosure, the automatic sheet feeding mechanism has a casing and an inlet tray, the inlet tray is disposed at one side of the casing, the channel roller group is arranged in the casing and at one side of the inlet tray, the casing has a sheet outlet, the sheet outlet is disposed under the inlet tray, the channel roller group is communicated with the inlet tray and the sheet outlet to define the scanning path.

In one embodiment of this disclosure, the scanning module is stacked on the casing, the channel roller group is disposed between the image sensor and the sheet outlet.

In one embodiment of this disclosure, the detachable scanning device further has a printing module, the power transmission module has at least the automatic sheet feeding mechanism, the automatic sheet feeding mechanism is stacked on the printing module, the printing module is configured to print a printed document.

In one embodiment of this disclosure, the printing module has an output tray and a stopper, the output tray is disposed under the automatic sheet feeding mechanism, the output tray is disposed at one side of the printing module, the stopper is disposed at another side of the printing module, the stopper can stop to position the printed document printed by the printing module and the document to be scanned driven by the automatic sheet feeding mechanism and scanned by the image sensor.

In one embodiment of this disclosure, the power transmission module has a first connection structure, the scanning module has a second connection structure, and the first connection structure is detachably connected to the second connection structure.

In one embodiment of this disclosure, the power transmission module has the automatic sheet feeding mechanism and the flat drag mechanism, and the scanning module and the flat drag mechanism are disposed together and pivoted to the automatic sheet feeding mechanism.

The detachable scanning device of this disclosure has a power transmission module having at least one of an automatic sheet feeding mechanism and a flat drag mechanism. The channel roller group of the automatic sheet feeding mechanism can transfer the document to be scanned along the scanning path so that the image sensor can scan the document to be scanned. The transferring part of the flat drag mechanism can move the image sensor from the housing into the casing along the lateral direction to scan the document to be scanned. Accordingly, a user can select a power transmission module according to various operation requirements, and the power transmission module can be quickly assembled to or detached from the scanning module.

### BRIEF DESCRIPTION OF THE DRAWINGS

The features of the disclosure believed to be novel are set forth with particularity in the appended claims. The disclosure itself, however, may be best understood by reference to the following detailed description of the disclosure, which describes a number of exemplary embodiments of the disclosure, taken in conjunction with the accompanying drawings, in which:

FIG. 1 is a perspective view showing the first embodiment of this disclosure.

FIG. 2 is a schematic view showing an operation status according to the first embodiment of this disclosure.

FIG. 3 is a perspective view showing the second embodiment of this disclosure.

FIG. 4 is a cross-sectional top view of the second embodiment of this disclosure.

FIG. 5 is a schematic view showing an operation status according to the second embodiment of this disclosure.

FIG. 6 is a perspective view showing the third embodiment of this disclosure.

FIG. 7 is a schematic view showing an operation status according to the third embodiment of this disclosure.

FIG. 8 is another schematic view showing an operation status according to the third embodiment of this disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

It should be understood that the orientations or positional relationships in this disclosure which are indicated by the terms such as “front side”, “rear side”, “left side”, “right side”, “front end”, “rear end”, “end”, “vertical”, “horizontal”, “vertical”, “top” and “bottom” are based on the orientations or positional relationships as shown in the drawings. These are only used for describing this disclosure and simplifying the description rather than indicating or implying that the device or element have a specific orientation or be constructed and operated in a specific orientation, and it should not be considered as limitations of the scopes of this disclosure.

The terms used herein without additional definition such as “substantially” and “approximately” are used to describe and illustrate small changes. When used in an event or situation, the term may include the precise moment at which the event or situation occurs, and a close approximation to moment the event or situation occurs. For example, when combined with a numerical value, the term may include a range of variation less than or equal to ±10% of the numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Detailed descriptions and technical contents of this disclosure is described in the flowing paragraph with reference to the drawings. However, the drawings are attached only for illustration and are not intended to limit this disclosure.

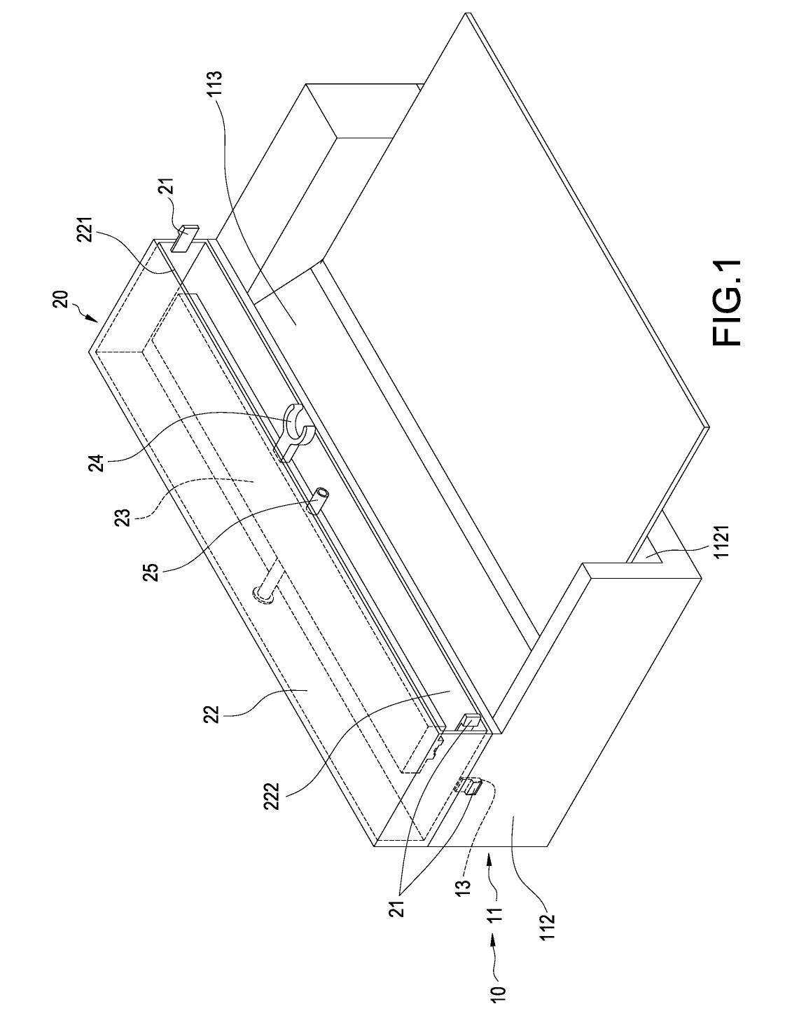

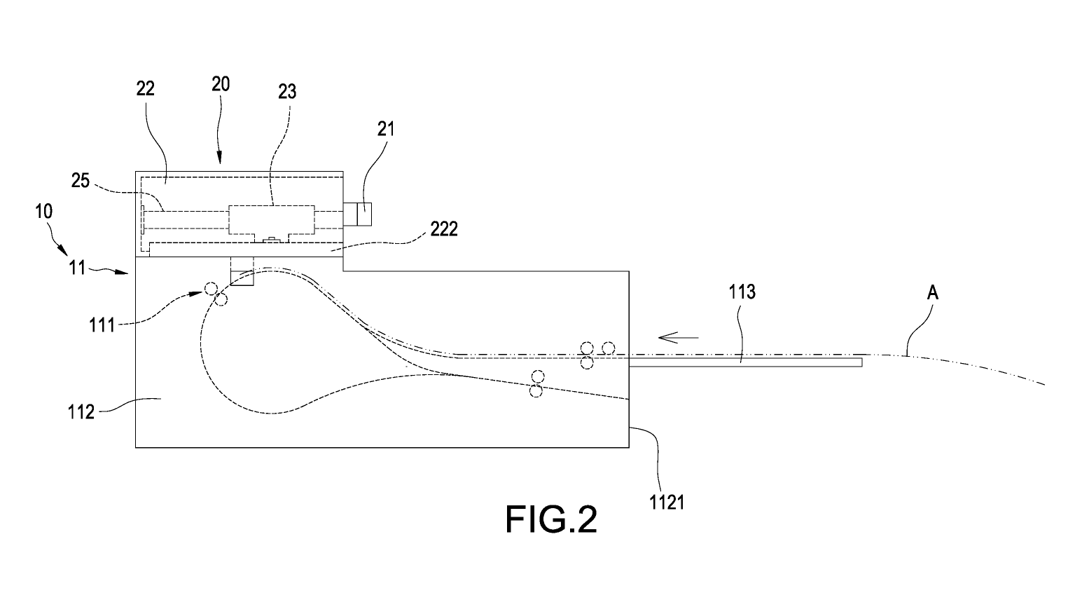

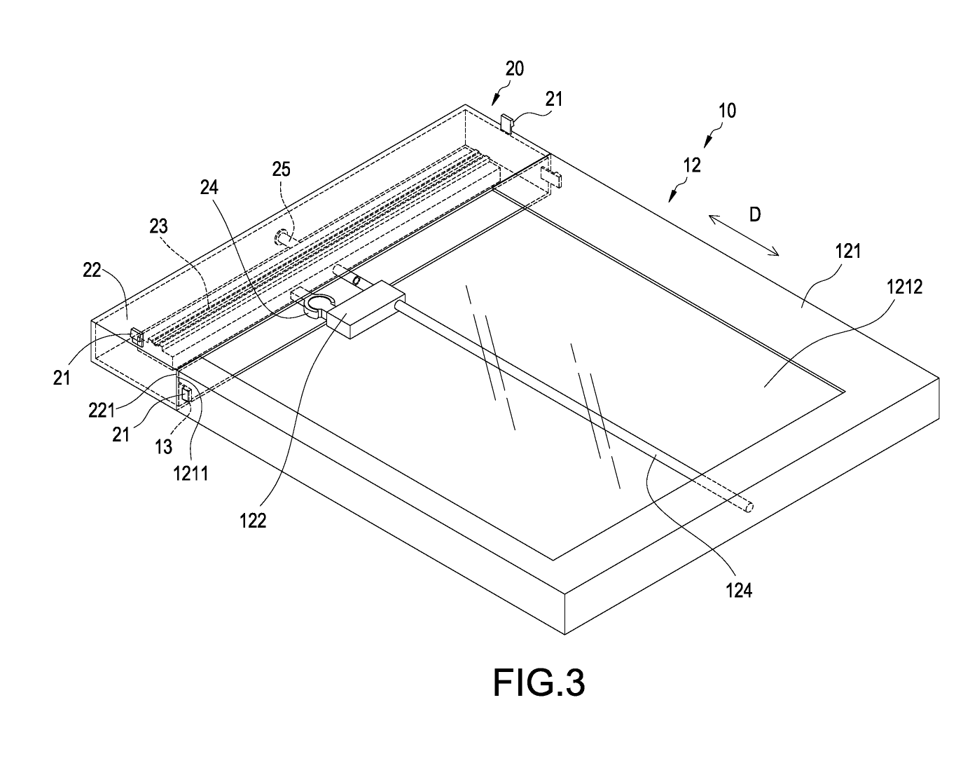

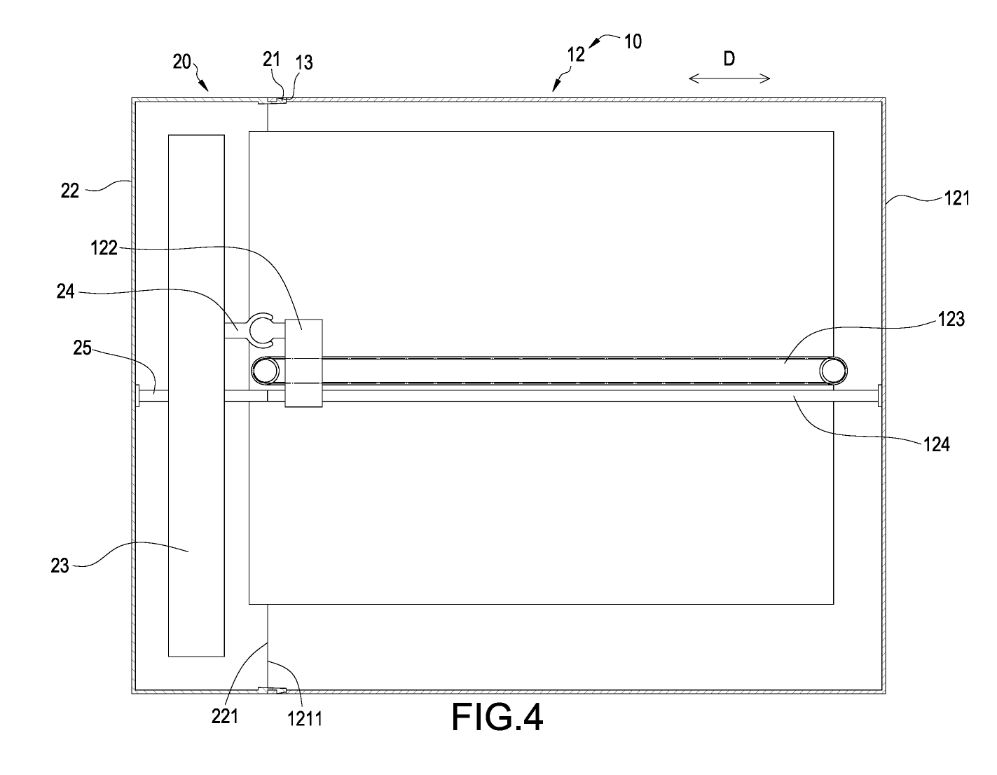

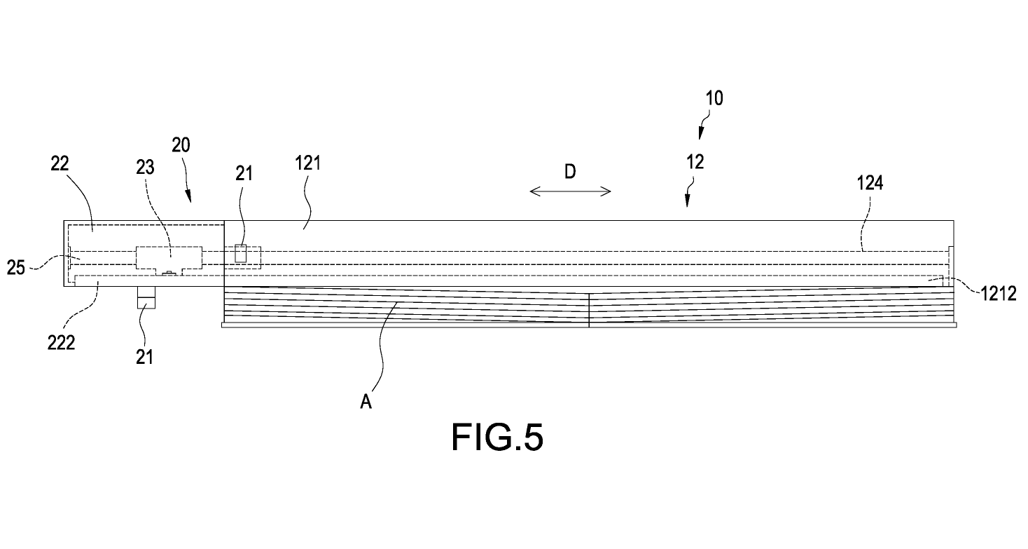

This disclosure is directed to a detachable scanning device, which is used for scanning a document A to be scanned. Referring to FIGS. 1 to 5, the detachable scanning device according to this disclosure at least has a power transmission module 10 and a scanning module 20. The first embodiment is illustrated in FIGS. 1 and 2, and the second embodiment is illustrated in FIGS. 3 to 5, detailed descriptions are recited following.

The power transmission module 10 at least has one of an automatic sheet feeding mechanism 11 and a flat drag mechanism 12. According to the first embodiment of this disclosure, the power transmission module 10 has only the automatic sheet feeding mechanism 11. According to the second embodiment of this disclosure, the power transmission module 10 has only the flat drag mechanism 12. However, the power transmission module 10 may have both of the automatic sheet feeding mechanism 11 and the flat drag mechanism 12 in other embodiments of this disclosure which are not detailly described following.

Referring to FIGS. 1 and 2, the automatic sheet feeding mechanism 11 has a channel roller group 111, a casing 112 and an inlet tray 113. The inlet tray 113 is disposed at one side of the casing 112 accommodating the document A to be scanned. The channel roller group 111 is disposed in the casing 112, and the channel roller group 111 is disposed at one side of the inlet tray 113. The casing 112 has a sheet outlet 1121. The sheet outlet 1121 is disposed under the inlet tray 113. The channel roller group 111 has a sheet conveying channel (not marked with numeral in figures) and a plurality of sheet driving rollers (not marked with numeral in figures). According to this embodiment, the sheet conveying channel is of a reversed U shape which has two ends respectively communicated to the inlet tray 113 and the sheet outlet 1121 to define a path for conveying the document A to be scanned from the inlet tray 113 to the sheet outlet 1121, but the scopes of this disclosure should not be limited to this. The sheet driving rollers are respectively disposed corresponding to the sheet conveying channel for conveying the document A to be scanned along the sheet conveying channel. Accordingly, the document A to be scanned is driven by the sheet driving rollers of the channel roller group 111 to be fed into the casing 112 from the inlet tray 113 and then flipped and output from the casing 112 through the sheet outlet 1121, so that the aforementioned path of the document A to be scanned is defined as a scanning path (not marked with numeral in the figures) to be scanned forms. In other words, the two ends of the sheet conveying channel of the channel roller group 111 are respectively connected to the inlet tray 113 and the sheet outlet 1121, so that the scanning path is defined by the inlet tray 113, the channel roller group 111 and the sheet outlet 1121.

Referring to FIGS. 3 to 5, the flat drag mechanism 12 has a casing 121, a transferring part 122 and a driver 123. The casing 121 has a first opening 1211 and a first light transmissive platform 1212. The first opening 1211 is disposed at one side of the casing 121, and the first light transmissive platform 1212 is disposed at a bottom of the casing 121. According to this embodiment, the first light transmissive platform 1212 is a transparent glass, but the scope of this disclosure should not be limited to the embodiment. The driver 123 is arranged in the casing 121. The transferring part 122 is arranged in the casing 121 to perform a reciprocating motion along a lateral direction D. Specifically, the transferring part 122 cane be driven by the driver 123 to perform a reciprocating motion along a lateral direction Din the casing 121. According to this embodiment, the driver 123 is a combination of pulleys and a belt, but the scope of this disclosure should not be limited to this. For example, the driver 123 may be a pneumatic cylinder, a hydraulic cylinder, a combination of a motor and a ball screw, or a linear slide, etc.

Referring to FIGS. 1 to 5 again, the scanning module 20 is detachably connected to the power transmission module 10. Specifically, the power transmission module 10 has at least a first connection structure 13, and the scanning module 20 has at least a second connection structure 21. The first connection structure 13 is detachably connected to the second connection structure 21. In this embodiment, the first connection structure 13 and the second connection structure 21 are counterpart buckles, but in another embodiment, the first connection structure 13 and the second connection structure 21 may be counterpart magnets or other forms of detachable structures. The scanning module 20 has a housing 22 and an image sensor 23. In this embodiment, each of the automatic sheet feeding mechanism 11 and the flat drag mechanism 12 is provided with a first connection structure 13 on one side corresponding to the scanning module 20. The scanning module 20 is provided with a second connection structure 21 on each of two sides corresponding to the automatic sheet feeding mechanism 11 and the flat drag mechanism 12, so that the scanning module 20 is able to be detachably connected to each of the automatic sheet feeding mechanism 11 and the flat drag mechanism 12. The housing 22 has a second opening 221 and a second light transmissive platform 222. The second opening 221 is disposed at one side of the housing 22, and the second light transmissive platform 222 is disposed at a bottom of the housing 22 so that the image sensor 23 is allowed to scan an object under scanning module 20. In this embodiment, the second light transmissive platform 222 is a transparent glass, but the scope of this disclosure should not be limited to this. The image sensor 23 is movably disposed in the housing 22, and the image sensor 23 can be moved outside the housing 22 through the second opening 221. In other words, the image sensor 23 may be operated without the housing 22 depending on needs. Further details are described in below.

Referring to FIGS. 1 and 2, again the scanning module 20 according to the first embodiment of this disclosure is stacked on the casing 112 of the automatic sheet feeding mechanism 11, thereby forming an automatic document feeder scanner (ADF scanner). The channel roller group 111 of the automatic sheet feeding mechanism 11 is disposed between the image sensor 23 of the scanning module 20 and the sheet outlet 1121 of the automatic sheet feeding mechanism 11. Accordingly, the channel roller group 111 can transfer the document A to be scanned in the inlet tray 113 along the scanning path when the scanning module 20 is connected to the automatic sheet feeding mechanism 11, so that the image sensor 23 can scan the document to be scanned A passing under the image sensor 23 through the second light transmissive platform 222. The document A to be scanned will be scanned and then output from the casing 112 of the automatic sheet feeding mechanism 11 through the sheet outlet 1121 to be stacked below the inlet tray 113 in sequence.

Referring to FIGS. 3 to 5 again, the scanning module 20 according to the second embodiment of this disclosure is disposed at one side of the flat drag mechanism 12, so that the second opening 221 on the housing 22 of the scanning module 20 and the first opening 1211 on the casing 121 of the flat drag mechanism 12 are communicate with each other and arranged opposite to each other, thereby forming a flatbed scanner. Accordingly, when the scanning module 20 is connected to the flat drag mechanism 12, a user may place the document A to be scanned under the flat drag mechanism 12 and the transferring part 122 is then moved by the driver 123, so that the image sensor 23 is driven by the transferring part 122 to translate from the housing 22 of the scanning module 20 along the lateral direction D into the casing 121 of the flat drag mechanism and pass the image sensor 23 translated along the lateral direction D, thereby scanning the document A to be scanned under the first light transmissive platform 1212.

Furthermore, the scanning module 20 also has a connecting piece 24. The connecting piece 24 is disposed on the image sensor 23. The connecting piece 24 of the scanning module 20 is connected to the transferring part 122 of the flat drag mechanism 12 when the scanning module 20 is connected to the flat drag mechanism 12, so that the two are linked with each other. Therefore, the image sensor 23 is meanwhile driven by the transferring part 122 to translate along the lateral direction D when the transferring part 122 is moved by the driver 123. According to this embodiment, the connecting piece 24 is a claw, and the claw is engaged with a protrusion on the transferring part 122 to form a link, but the scope of this disclosure should not be limited to this. For example, the connecting piece 24 and the transferring part 122 may be connected by snap fastening or magnetic attraction.

In addition, the flat drag mechanism 12 according to this embodiment has a slide rod 124 for ensuring the part 122 stably translates the image sensor 23 along the lateral direction D without skew. The slide rod 124 is extended along the lateral direction D, and the slide rod 124 is fixed in the casing 121. The transferring part 122 sleeves the slide rod 124 so that the transferring part 122 can stably slide on the slide rod 124 along the lateral direction D without skew. In addition, the scanning module 20 according to this embodiment has a connecting rod 25. The connecting rod 25 is disposed in the housing 22 of the scanning module 20, and the connecting rod 25 can be assembled with the slide rod 124 to increase the structural stability of the slide rod 124, so that a translational motion along the lateral direction D performed by the transferring part 122 is more stable. It should be noted that a connection between the connecting rod 25 and the slide rod 124 may be screw connection, plug-in connection, snap-on connection, locking connection, magnetic connection or key positioning, etc., but the scopes of this disclosure should not be limited to this.

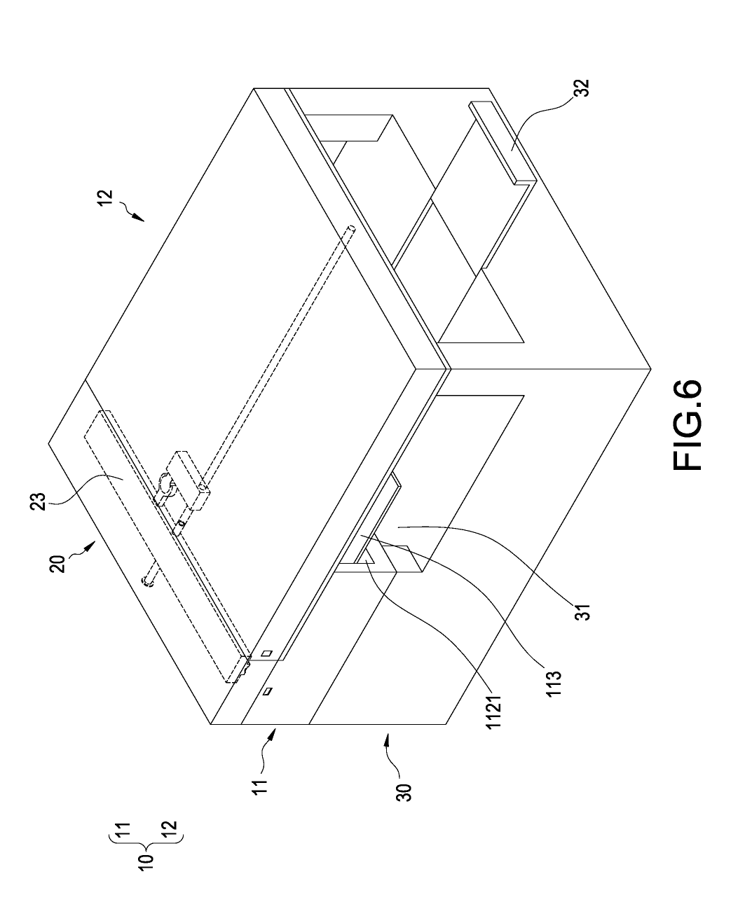

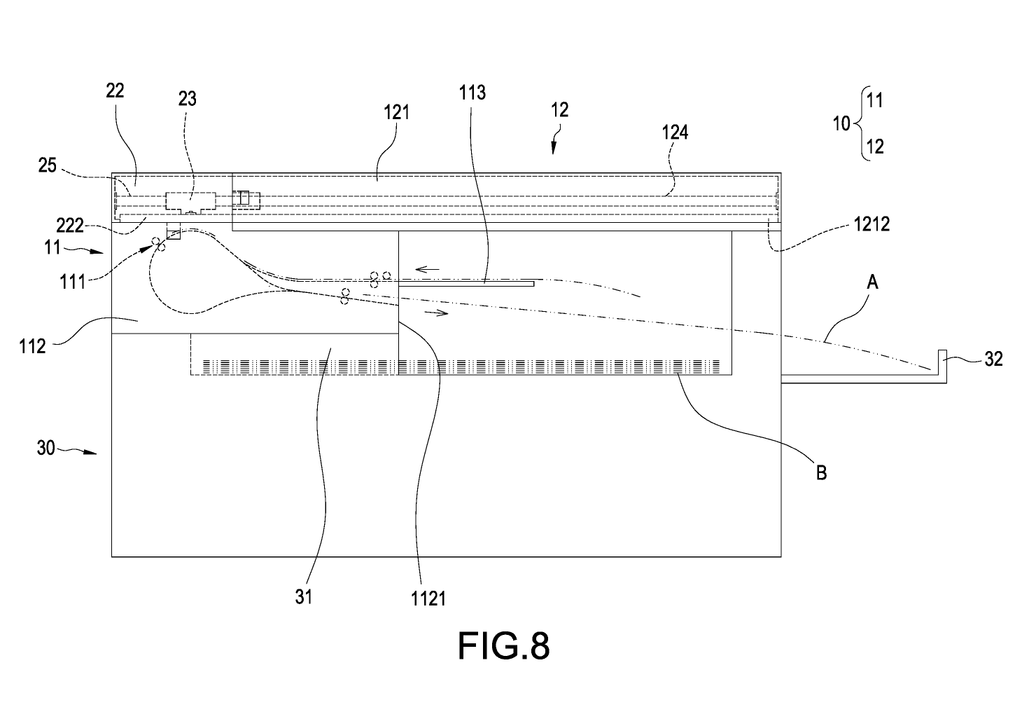

According to the third embodiment of this disclosure as shown in FIGS. 6 to 8. The third embodiment difference is different from the first and the second embodiments in that the third embodiment further has a printing module 30, and the power transmission module 10 at least has an automatic sheet feeding mechanism 11. The power transmission module 10 as shown in the figures of this embodiment has both of an automatic sheet feeding mechanism 11 and a flat drag mechanism 12, thereby forming a multi-function product (MFP), but the third embodiment of the present disclosure should not be limited to this. For example, the power transmission module 10 may have only the automatic sheet feeding mechanism 11. The automatic sheet feeding mechanism 11 is stacked on the printing module 30. The printing module 30 is used for printing a printed document B. The printing module 30 has an output tray 31 and a stopper 32. The output tray 31 is disposed under the automatic sheet feeding mechanism 11. The output tray 31 and the automatic sheet feeding mechanism 11 are disposed together on one side of the printing module 30, and the stopper 32 is disposed on another side of the printing module 30. Therefore, both of the printed document B printed by the printing module 30 and the document A to be scanned driven by the automatic sheet feeding mechanism 11 and scanned by the image sensor 23 can be stopped and positioned by the stopper 32, so that the printed document B and the scanned document A are prevented from scattering. In other words, the stopper 32 is used for both of the sheet outlet 1121 of the automatic sheet feeding mechanism 11 and the output tray 31 of the printing module 30, so that the detachable scanning device of this disclosure disclosed may be thinner.

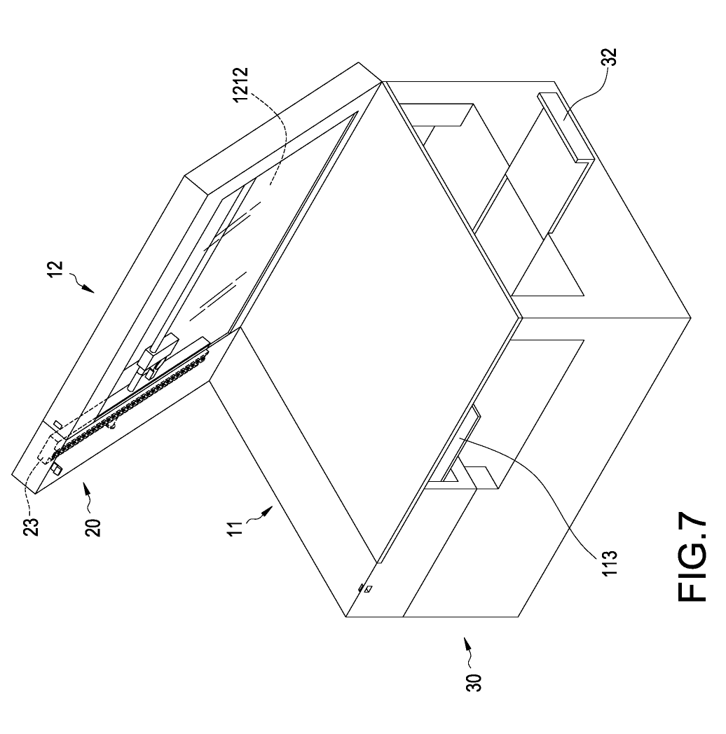

Furthermore, the power transmission module 10 as shown in the figures according to the third embodiment of this disclosure has both of an automatic sheet feeding mechanism 11 and a flat drag mechanism 12. For the convenience of the user to place the document A to be scanned under the flat drag mechanism 12, the scanning module 20 and the flat drag mechanism 12 are disposed together and pivoted to the automatic sheet feeding mechanism 11, so that the scanning module 20 and the flat drag mechanism 12 can be pivotally turn up relative to the automatic sheet feeding mechanism 11 and the printing module 30 as shown in FIG. 7.

In addition, the document A to be scanned is placed under the flat drag mechanism 12, and the image sensor 23 scans the document to be scanned downward. Therefore, when the document A to be scanned is a bound document such as a book, the user may pivotally turn up the scanning module 20 and the flat drag mechanism 12 relative to the automatic sheet feeding mechanism 11 and the printing module 30 after scanning a page and then flip a page of the document A to be scanned to the next page for further scanning. Regarding a scanning device of related art, the bound document such as a book is placed face down on a top of the scanning module 20 for scanning, and after scanning a single page, the bound document should be flipped over for flipping page, and then the bound document should be flipped over and placed on the top of the scanning module 20 for further scanning. Regarding the detachable scanning device of this disclosure, redundant actions when turning pages are effectively omitted to save operation time, and the user may quickly and conveniently perform continuous scanning to a bound document such as a book.

The detachable scanning device of this disclosure has a power transmission module 10 having at least one of an automatic sheet feeding mechanism 11 and a flat drag mechanism 12. The channel roller group 111 of the automatic sheet feeding mechanism 11 can transfer the document A to be scanned along the scanning path so that the image sensor 23 can scan the document A to be scanned. The transferring part 122 of the flat drag mechanism 12 can move the image sensor 23 from the housing 22 into the casing 121 along the lateral direction D to scan the document A to be scanned. Accordingly, a user can select a power transmission module 10 according to various operation requirements, and the power transmission module 10 can be quickly assembled to or detached from the scanning module 20.

While this disclosure has been described by means of specific embodiments, numerous modifications and variations could be made thereto by those skilled in the art without departing from the scope and spirit of this disclosure set forth in the claims.

What is claimed is:

1. A detachable scanning device, used for scanning a document to be scanned, the detachable scanning device comprising:
a power transmission module, comprising at least one of an automatic sheet feeding mechanism and a flat drag mechanism, the automatic sheet feeding mechanism comprising a channel roller group, the flat drag mechanism comprising a casing and a transferring part, wherein the transferring part is arranged in the casing to perform a reciprocating motion along a lateral direction; and
a scanning module, detachably connected to the power transmission module, the scanning module comprising a housing and an image sensor, the image sensor movably disposed in the housing;
wherein when the scanning module is connected to the automatic sheet feeding mechanism, the channel roller group is configured to transfer the document to be scanned along a scanning path to scan the document to be scanned by the image sensor;
wherein when the scanning module is connected to the flat drag mechanism, the transferring part is configured to move the image sensor along the lateral direction from the housing into the casing to scan the document to be scanned.

2. The detachable scanning device according to claim 1, wherein the flat drag mechanism further comprises a driver, the scanning module further comprises a connecting piece, the connecting piece is arranged on the image sensor, the connecting piece is connected to the transferring part when the scanning module is connected to the flat drag mechanism, so that the driver is configured to drive the transferring part to move the image sensor along the lateral direction.

3. The detachable scanning device according to claim 2, wherein the flat drag mechanism further comprises a slide rod, the slide rod is fixed in the casing and extended along the lateral direction, the transferring part sleeves the slide rod and disposed on the slide rod slidably along the lateral direction.

4. The detachable scanning device according to claim 3, wherein the scanning module further comprises a connecting rod, the connecting rod is arranged in the housing, and the connecting rod is assembled with the slide rod.

5. The detachable scanning device according to claim 1, wherein the automatic sheet feeding mechanism comprises a casing and an inlet tray, the inlet tray is disposed at one side of the casing, the channel roller group is arranged in the casing and at one side of the inlet tray, the casing comprises a sheet outlet, the sheet outlet is disposed under the inlet tray, the channel roller group is communicated with the inlet tray and sheet outlet to define the scanning path.

6. The detachable scanning device according to claim 5, wherein the scanning module is stacked on the casing, the channel roller group is disposed between the image sensor and the sheet outlet.

7. The detachable scanning device according to claim 1, further comprising a printing module, the power transmission module comprising at least the automatic sheet feeding mechanism, the automatic sheet feeding mechanism stacked on the printing module, and the printing module configured to print a printed document.

8. The detachable scanning device according to claim 7, wherein the printing module comprises an output tray and a stopper, the output tray is disposed under the automatic sheet feeding mechanism, the output tray is disposed at one side of the printing module, the stopper is disposed at another side of the printing module, the stopper is configured to stop and position the printed document printed by the printing module and the document to be scanned driven by the automatic sheet feeding mechanism and scanned by the image sensor.

9. The detachable scanning device according to claim 1, wherein the power transmission module comprises a first connection structure, the scanning module comprises a second connection structure, and the first connection structure is detachably connected to the second connection structure.

10. The detachable scanning device according to claim 1, wherein the power transmission module comprises the automatic sheet feeding mechanism and the flat drag mechanism, and the scanning module and the flat drag mechanism are disposed together and pivoted to the automatic sheet feeding mechanism.
